(19) United States
(12) Patent Application Publication
(10) Pub. No.: US 2025/0233374 A1
(43) Pub. Date: Jul. 17, 2025

(54) ELECTRICAL CONNECTION ARRANGEMENT FOR REDUCING ARC ENERGY AND EROSION IN A CONTACT SYSTEM

(71) Applicant: Eaton Intelligent Power Limited, Dublin 4 (IE)

(72) Inventors: Toni OTT, Neckargemünd (DE); Marco KNAB, Eberbach (DE); Lars WISCHGOLL, Gemmingen (DE)

(21) Appl. No.: 18/697,717

(22) PCT Filed: Sep. 30, 2022
(86) PCT No.: PCT/EP2022/025455

§ 371 Date: Apr. 1, 2024

Related U.S. Application Data
(60) Provisional application No. 63/250,430, filed on Sep. 30, 2021.

(30) Foreign Application Priority Data
Sep. 30, 2021 (DE) 102021125379.9
Sep. 22, 2022 (DE) 102022124417.2

(51) Int. Cl. H01R 13/703; H01R 13/03; H01R 13/187

(52) U.S. Cl. CPC H01R 13/7032; H01R 13/03; H01R 13/187

(57) ABSTRACT

An electrical connection arrangement includes a first circuit path that has a first electrical resistance and a second circuit path having a second electrical resistance that is lower than the first electrical resistance. The electrical connection arrangement can be configured to provide a connection sequence for electrically connecting the first and second electrical conductors. The connection sequence can include a) a first electrical connection state in which the first and second electrical conductors are not electrically connected; b) a second electrical connection state in which the first and second electrical conductors are electrically connected by the first circuit path and are not electrically connected by the second circuit path; and c) a third electrical connection state in which the first and second electrical conductors are electrically connected by the first circuit path and by the second circuit path.

### TECHNICAL FIELD

The present disclosure relates generally to electrical devices for providing circuit interruptions such as plug and socket systems and switching systems.

### BACKGROUND

Electrical systems such as plug and receptacle systems (i.e., plug and socket systems) and switch systems are used to provide circuit interruptions. When such systems are electrically connected or electrically disconnected while under electrical load, arcing can occur. Arcing can cause component erosion that negatively impacts system performance. In certain cases where the arc energy is sufficiently high, ionization related short circuiting may occur. Improvements in this area are desirable.

### SUMMARY

The present disclosure relates generally to an electrical connection arrangement including a contact system that is sequenced to reducing arc energy resulting from electrical connection and disconnection of the system under electrical load. The electrical connection arrangement can also reduce erosion of the contact system resulting from electrical arcing. The electrical connection arrangement includes first and second circuit paths having different electrical resistances or impedances. When making an electrical connection under load, the circuit path with the higher resistance is connected before the circuit path with the lower resistance to reduce arc energy. Similarly, when making an electrical disconnection under load, the circuit path with the lower resistance is disconnected before the circuit path with the higher resistance to reduce arc energy. The term “resistance” as used herein is defined generally to represent a comprehensive expression of any and all forms of opposition to a flow of electrons in electrical systems. For example, in direct current systems, resistance can be quantified using real values (e.g., resistive Ohms); in alternating current systems, resistance can represent a component of impedance, wherein impedance is quantified by a combination of real values (e.g., resistive Ohms) and imaginary values.

In one example, the electrical connection arrangement is integrated in a plug and socket, wherein the resistances of the circuit paths are made different by providing first and second louvered pin contacts (i.e., lamellas) made of different materials having different electrical resistivities within a pin receiver of the socket. In another example, the electrical connection arrangement is integrated into a switch such as a linear switch, wherein the resistances of the circuit paths are made different by providing spring and pad contacts made of different materials having different electrical resistivities. In certain examples, the material having a higher electrical resistivity (i.e., the lower electrical conductivity) also is more erosion resistant that the material having the lower electrical resistivity (i.e., the higher electrical conductivity). In one example, the material having the higher electrical resistivity includes stainless steel, and the material having the lower electrical resistivity includes copper or silver, or aluminum or combinations thereof. An electrical connection arrangement according to the present disclosure is advantageous to reduce arcing energy during electrical connections and disconnections and for reducing arc related erosion of the connection arrangement. The electrical connection arrangement can be incorporated in a linear switch and a plug and receptacle system (e.g., wall socket/plug outlet).

This present disclosure addresses the above-identified arcing problem with a new and cost-effective solution. The electrical connection arrangement of the present disclosure includes two contact elements that can be made of two different materials. For example, a first contact element can be made of a higher electrical resistivity material such as stainless steel and a second contact element can be made of a lower electrical resistivity material such as copper, silver, or aluminum. The different materials are sequentially electrically connected during the transitional phase of connecting and disconnecting to help reduce arcing.

One aspect of the present disclosure relates to an electrical connection arrangement for electrically connecting a first electrical conductor to a second electrical conductor. The electrical connection arrangement includes a first circuit path that has a first electrical resistance and a second circuit path having a second electrical resistance that is lower than the first electrical resistance. The electrical connection arrangement can be configured to provide a connection sequence for electrically connecting the first and second electrical conductors. The connection sequence can include a) a first electrical connection state in which the first and second electrical conductors are not electrically connected; b) a second electrical connection state in which the first and second electrical conductors are electrically connected by the first circuit path and are not electrically connected by the second circuit path; and c) a third electrical connection state in which the first and second electrical conductors are electrically connected by the first circuit path and by the second circuit path. During the connection sequence the second electrical connection state occurs sequentially after the first electrical connection state and the third electrical connection state occurs sequentially after the second electrical connection state.

These and other features and advantages will be apparent from a reading of the following detailed description and a review of the associated drawings. A variety of additional aspects will be set forth in the description that follows. These aspects can relate to individual features and to combinations of features. It is to be understood that both the foregoing general description and the following detailed description are exemplary and explanatory only and are not restrictive of the broad concepts upon which the embodiments disclosed herein are based.

### BRIEF DESCRIPTION OF THE DRAWINGS

The following drawings are illustrative of particular embodiments of the present disclosure and therefore do not limit the scope of the present disclosure. Embodiments of the present disclosure will hereinafter be described in conjunction with the appended drawings, wherein like numerals denote like elements.

FIG. 1 labeled “prior art” illustrates a cross-sectional view of an example plug and receptacle connection.

FIG. 2 illustrates a plug-and-socket system including an electrical connection arrangement in accordance with principles of the present disclosure.

FIG. 3 illustrates the plug-and-socket system of FIG. 2 showing a contact pin of the plug in a first axial position within the socket at a first contact lamella.

FIG. 4 illustrates the plug-and-socket system of FIG. 2 showing the contact pin of the plug in a second axial position within the socket at a second contact lamella.

FIG. 5 illustrates the plug-and-socket system of FIG. 2 showing the contact pin of the plug in a third axial position within the socket and disconnected at the first contact lamella.

FIG. 6 illustrates an exploded view of a conventional linear switch in an open position.

FIG. 7 illustrates a side cross-sectional view of the linear switch of FIG. 6 in a closed position.

FIG. 8 illustrates a schematic view of a linear switch in an open position that includes another electrical connection arrangement in accordance with the principles of the present disclosure.

FIG. 9 illustrates a schematic view of the switch of FIG. 8 in a semi-opened position.

FIG. 10 illustrates a schematic view of the linear switch of FIG. 8 in a closed position.

### DETAILED DESCRIPTION

Various embodiments of the present invention will be described in detail with reference to the drawings, wherein like reference numerals represent like parts and assemblies throughout the several views. Reference to various embodiments does not limit the scope of the invention. Additionally, any examples set forth in this specification are not intended to be limiting and merely set forth some of the many possible embodiments.

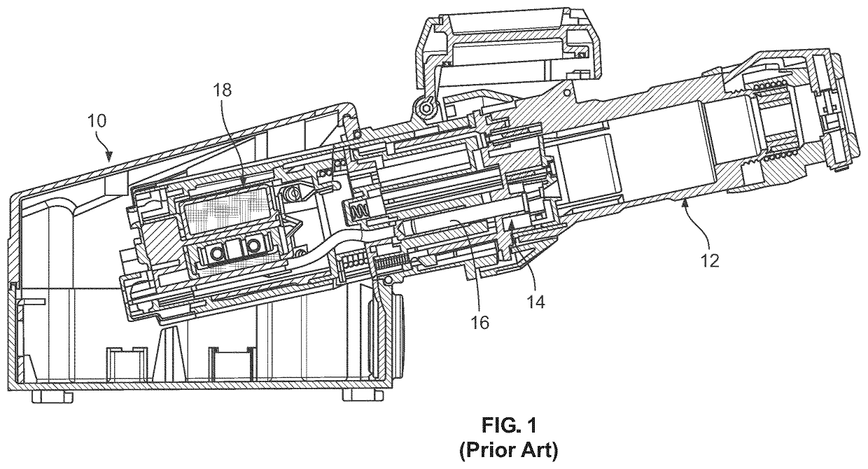

As presented at FIG. 1, an example conventional wall socket 10 and plug 12 connection is depicted. A lamella contact 14 (i.e., a louvered contact including a plurality of slats circumferentially positioned to provide a multitude of contact locations about the circumference of a pin inserted into the contact) is positioned within the wall socket 10 for a corresponding receiving pin 16 of the plug 12 to make an electrical connection when the plug 12 is inserted into the wall socket 10. It will be appreciated that the plug 12 typically includes a plurality of pins 16, and the socket 10 typically includes a plurality of the lamella contacts 14 each configured for receiving a different pin of the plug 12. A switch 18 can be positioned within the wall socket 10. Typically, the switch 18 is activated to disconnect a load which allows the plug 12 to be disconnected and removed. In some examples, the connection and disconnection of the plug 12 is performed under load which may cause erosion which damages the plug and receptacle (P&R) system. For example, arc related erosion may affect the resistance on the lamella contacts 14 leading to lower switching capabilities and a rise in heat. Also, erosion of the housing of the socket can produce carbon dust that may negatively affect the isolation resistance of the device.

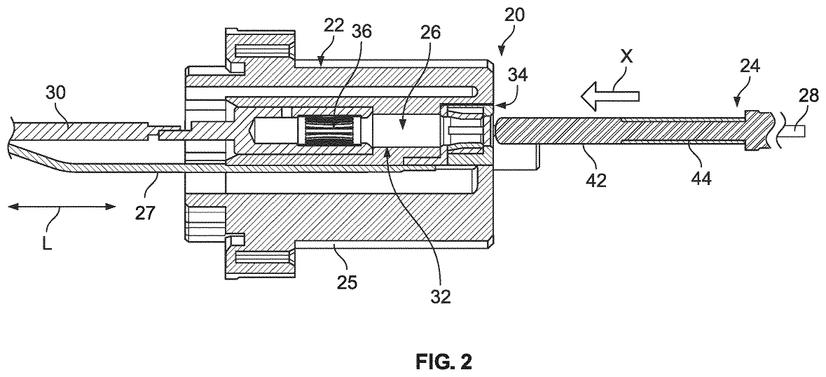

Typically, a P&R system includes a relatively low electrical resistance electrical connection between a given one of the pins 16 and its corresponding lamella contact 14 by constructing the lamella contact 14 of a material having a relatively low electrical resistivity. The present disclosure relates to an electrical connection arrangement that adds another lamella contact having a higher electrical resistivity than the lower electrical resistivity lamella contact 14 to each pin receiver of the socket. Both of the lamella contacts of each pin receiver are adapted to make electrical contact with the same pin. During electrical connections and disconnections, the timing that contact is made between the pin and the different lamella contacts is sequenced to reduce arc energy. Turning to FIG. 2, an example plug-and-socket system 20 is depicted in accordance with the principles of the present disclosure. The plug-and-socket system 20 is configured for making electrical connections between pins of a plug and contacts within a socket such as a wall socket. The plug can have one, two, three, four, five, six, seven or more pins. FIG. 2 shows one example pin 24 (e.g., an electrically conductive pin) of the plug co-axially aligned with an example pin receiver 22 positioned within the socket of the system 20.

The plug-and-socket system 20 includes an electrical connection arrangement 26 that provides a connection sequence for electrically connecting a first electrical conductor 28 such as a wire electrically connected to the pin 24 to a second electrical conductor 30 such as a wire electrically connected to the pin receiver 22.

The pin receiver 22 includes a contact zone 32 in which the electrical connection arrangement 26 includes a first contact lamella 34 (e.g., a first pin contact) and a second contact lamella 36 (e.g., a second pin contact). The first contact lamella 34 can be aligned along a longitudinal direction (L) in relation to the second contact lamella 36. A socket housing 25 can support the components of the electrical connection arrangement 26 and isolates them from one another.

In certain examples, the first contact lamella 34 can be made of a first material and the second contact lamella 36 can be made of a second material in which the first material has a higher electrical resistivity than the second material to reduce the arc energy during an electrical disconnection or connection. In certain examples, the first material may be a more arc erosion resistant material than the second material. In one example, the first material includes stainless steel, and the second material may include copper, silver, nickel or a combination of copper, silver, and nickel. In certain examples, the pin 24 can be made of a lower electrical resistance material, such as, stainless steel.

In other examples, the first and second contact lamellas 34, 36 may be made of the same material. In such a configuration, by-pass conductor 27 may be made of a higher resistance material or alternatively, a resistor may be added to the system.

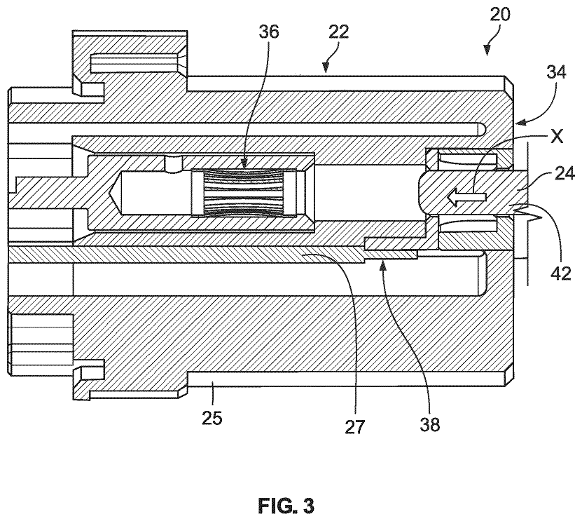

Referring to FIG. 3, the pin 24 is shown introduced into the contact zone 32 such that the first contact lamella 34 of the contact receiver 22 is elastically deformed, radially outwards, to close against the pin 24 under a mechanical preload such that an electrical connection is made between the pin 24 and the first contact lamella 34. The contact pin 24 of the plug is inserted inwardly into the pin receiver 22 along an insertion axis X to provide an electrical connection between the first and second electrical conductors 28, 30 through the first lamella 34 but not the second lamella 36. The first lamella 34 is electrically connected to the second electrical conductor 30 by a bypass conductor 27. The first lamella 34 and the bypass conductor 27 form a first circuit path 38 between the pin receiver 22 and the second electrical conductor 30 for interconnecting the first and second conductors 28, 30 when the pin 24 is in the axial position of FIG. 3. The first circuit path 38 connects the pin 24 to the second conductor 30 when the pin 24 is in the axial position of FIG. 3. The first circuit path 38 has a first electrical resistance dependent at least in part on the higher electrical resistivity of the first lamella 34.

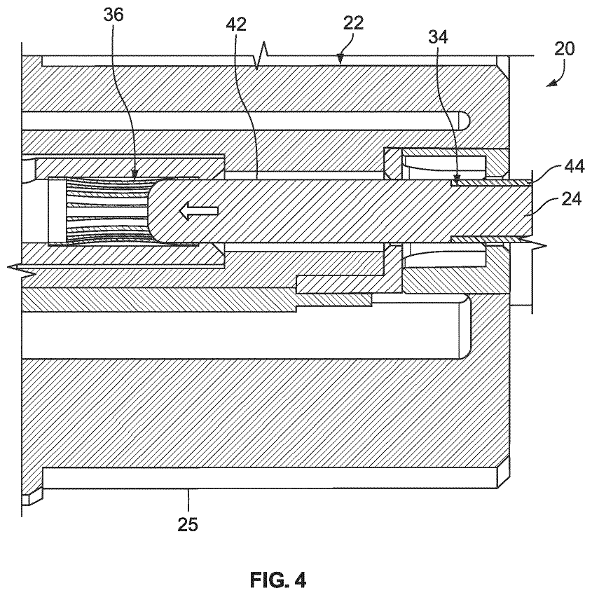

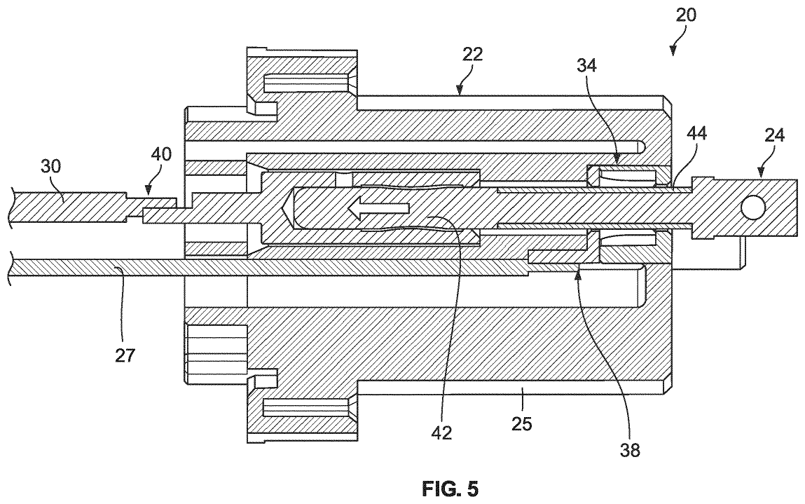

The second contact lamella 36 connects directly to the second electrical conductor 30 thereby defining a second circuit path 40 between pin receiver 22 and the second electrical conductor 30 that is separate from the first circuit path 38. When the pin 24 is in the axial position of FIG. 4, the pin 24 electrically connects with both the first circuit path 38 via the first lamella 34 and the second circuit path 40 via the second lamella 36. Hence, the first and second conductors 28, 30 are electrically connected by both the first and second circuit paths 28, 30. Since the second circuit path 40 is defined by the second contact lamella 36 having the second electrical resistivity, the second circuit path 40 has a lower resistance than the first circuit path 38. When the pin 24 is axially moved to a fully inserted position as shown at FIG. 5, the pin 24 remains electrically connected to the second lamella 36 and a dielectric portion 44 of the pin 24 prevents the pin 24 from being electrically connected to the first lamella 34. Hence, in the fully inserted position of the plug, only the second circuit path 40 electrically connects the first and second conductors 28, 30 to each other.

The electrical connection arrangement 26 can be configured to provide a connection sequence for electrically connecting the first and second electrical conductors 28, 30. For example, the connection sequence can include the following: a) a first electrical connection state in which the first and second electrical conductors 28, 30 are not electrically connected (see FIG. 2); b) a second electrical connection state in which the first and second electrical conductors 28, 30 are electrically connected by the first circuit path 38 and are not electrically connected by the second circuit path 40 (see FIG. 3); and c) a third electrical connection state in which the first and second electrical conductors 28, 30 are electrically connected by the first circuit path 38 and by the second circuit path 40 (see FIG. 4). During the connection sequence, the second electrical connection state occurs sequentially after the first electrical connection state and the third electrical connection state occurs sequentially after the second electrical connection state.

The first circuit path 38 includes the first contact lamella 34 electrically connected to the second electrical conductor 30 by the by-pass conductor 27. The second circuit path 40 includes the second contact lamella 36 electrically connected to the second electrical conductor 30. The second contact lamella 36 is inwardly offset along the insertion axis X from the first contact lamella 34 within the pin receiver 22.

The contact pin 24 of the plug includes an electrically conductive portion 42 and the dielectric portion 44. The electrically conductive portion 42 contacts the first contact lamella 34 and not the second contact lamella 36 when the electrical connection arrangement 26 is in the second electrical connection state (see FIG. 3). When in the second electrical connection state, the contact pin 24 of the plug is at a first axial position within the pin receiver 22 (se FIG. 3).

The electrically conductive portion 42 contacts both the first and second contact lamellas 34, 36 when the electrical connection arrangement 26 is in the third electrical connection state (see FIG. 4) such that the first and second electrical conductors 28, 30 are connected in parallel by the first and second circuit paths 38, 40. When in the third electrical connection state, the contact pin 24 of the plug is at a second axial position within the pin receiver 22.

The electrically conductive portion 42 contacts the second contact lamella 36 and the dielectric portion 44 contacts the first contact lamella 34 when the electrical connection arrangement 26 is the fourth electrical connection state (see FIG. 5). When in the fourth electrical connection state, the contact pin 24 of the plug is at a third axial position within the pin receiver 22 and is no longer electrically connected to the first contact lamella 34 to provide the electrical connection through only the lower electrical resistance material of the second contact lamella 36. When in the fourth electrical connection state, the first and second electrical conductors 28, 30 are electrically connected by the second circuit path 40 and not by the first circuit path 38. The fourth electrical connection state occurs sequentially after the third electrical connection state.

As depicted in FIGS. 3-5, the contact pin 24 of the plug is inserted progressively further into the pin receiver 22 as the contact pin 24 of the plug is moved from the first axial position through the second axial position to the third axial position. The electrical connection arrangement 26 is configured to provide a disconnection sequence for electrically disconnecting the first and second electrical conductors 28, 30. During the disconnection sequence, the electrical connection arrangement 26 sequentially moves from the third electrical connection state to the second electrical connection state, and then from the second electrical connection state to the first electrical connection state. As the plug is removed, the contact pin 24 is first separated from the low resistance material of the second contact lamella 36. As the plug is continuously moved linearly backwards, the contact pin 24 can be disconnected from the high resistance material of the first contact lamella 34.

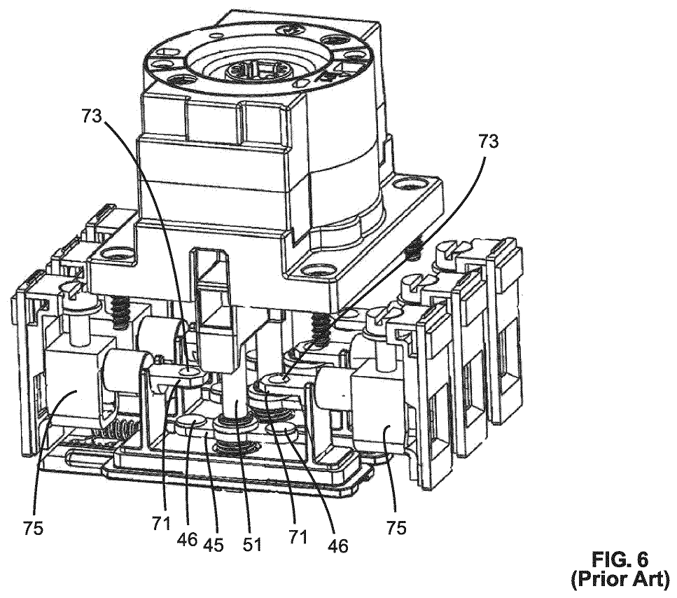

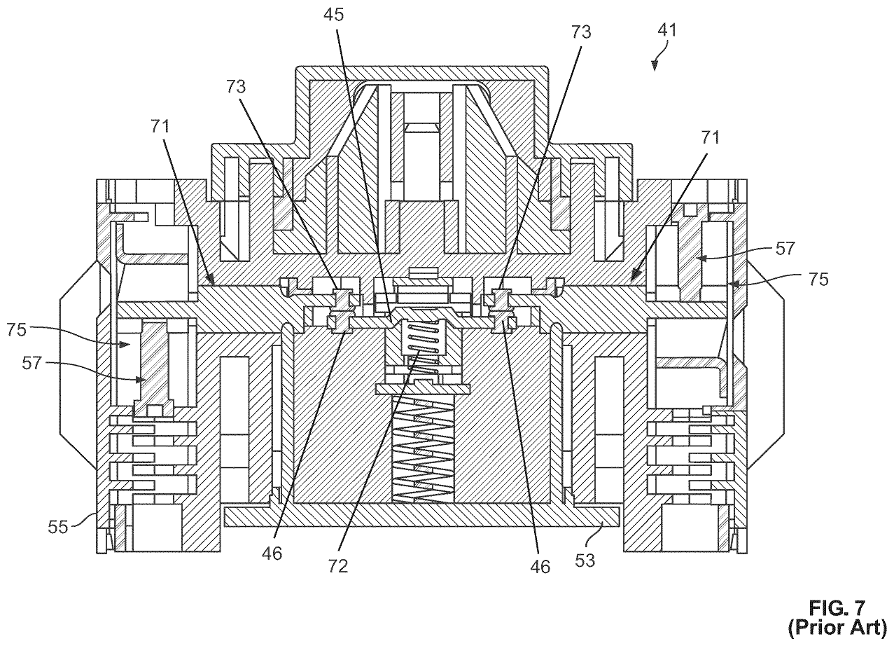

Turning now to FIGS. 6-7, a prior art switching device is depicted. The switching device includes a plurality of linear switches 41 each corresponding to a separate interrupter chamber. Further details for this type of switch is disclosed in PCT Patent Application No. WO 2020/098970, which is incorporated by reference herein in its entirety.

Each of the linear switches 41 includes fixed contacts 71 supported by a base 53. The fixed contacts 71 each include a contact pad 73. The contact pads 73 are separated by a gap that can be closed by a linearly moveable bridge 45 having contact pads 46 aligned with the contact pads 73 of the fixed contacts 71. The fixed contacts include clamps 75 having clamping screws 57 for electrically connecting electrical conductors (e.g., electrical wires/cables) to the fixed contacts 71. The moveable bridge 45 is spring-biased by a spring 72 toward a closed-circuit position (see FIG. 7) in which the contact pads 46 of the bridge 45 contact the contact pads 73 of the fixed contacts such that the fixed contacts are electrically connected to each other by the bridge 45. A cam actuated plunger 51 is adapted to linearly move the bridge 45 away from the fixed contacts 71 against the bias of the spring 72 to an open-circuit position (see FIG. 6) in which the fixed contacts are not electrically connected together by the bridge 45. Actuation of the cam actuated plunger 51 allows the bridge 45 to be moved between the open-circuit position and the closed-circuit positions. An electrical connection is provided between the fixed contacts 71 and the corresponding wires/cables electrically connected thereto when the bridge 45 is in the closed-circuit position. The electrical connection between the fixed contacts 71 is interrupted when the bridge is in the open-circuit position.

The present disclosure is also directed to improving electrical switching apparatuses to reduce arcing energy during electrical connections and disconnections made under electrical load. To protect electric installations against the damaging effects of arcing, switches are provided with multiple circuit paths with different electrical resistances that can be utilized in sequence to reduce arc energy and reduce arc related contact and housing erosion. In certain examples, one of the circuit paths can include contacts made of erosion resistance material a having first electrical resistivity, and the other circuit path can include contacts made of a material having a second electrical resistivity lower than the first electrical resistivity.

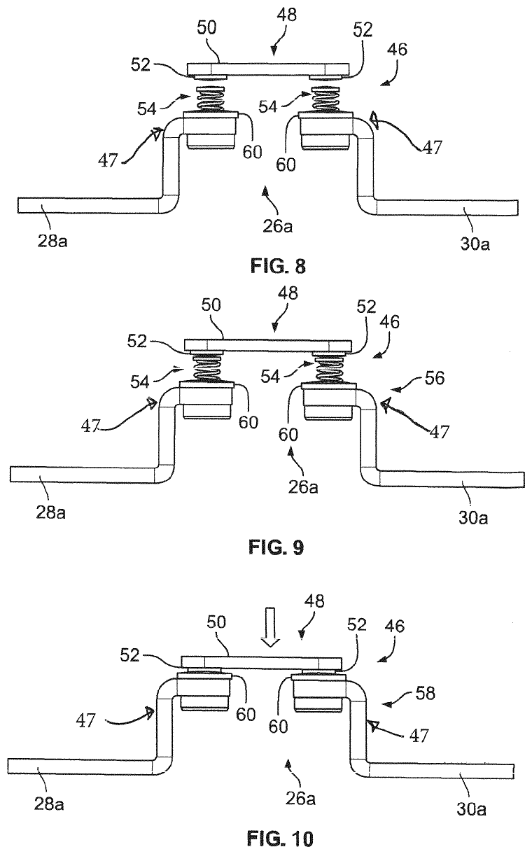

Turning to FIG. 8, another electrical connection arrangement 26a is shown incorporated in a second embodiment in accordance with the principles of the present disclosure as part of a linear electric switching unit 46 that in certain examples can be integrated into a multi-switch switching device of the type described above having multiple switches positioned in separate interrupter chambers. The switching unit 46 can include a moveable contact unit 48 that includes a contact bridge 50 and pad contacts 52 (e.g., flat rivets). The switching unit 46 also includes fixed contacts 47 including pad contacts 60 (e.g., rivets) defining internal pockets in which spring contacts 54 are mounted and into which the spring contacts 54 can be compressed. The pad contacts 60 and the spring contacts 54 of each fixed contact 47 align with a corresponding one of the pad contacts of the moveable contact unit 48. The fixed contacts 47 are each electrically connected to a separate electrical conductor 28a, 30a. The electrical conductors 28a, 30a can include electrical wires/cables and the fixed contacts can include clamps or other structures for making electrical connections with the electrical wires/cables. The moveable contact unit 48 can be moved relative to the fixed contacts 47 to different electrical connection states by an actuation arrangement. The actuation arrangement can include a cam actuated plunger and one or more springs.

In certain examples, the spring contacts 54 of the fixed contacts 47 can be made of a first material and the pad contacts 52 can be made of a second material. Similar to the first and second materials of the first and second contact lamellas 34, 36 described above, the first material of the spring contacts 54 can have a higher electrical resistivity than the second material of the pad contacts 52. In other examples, a resistor may be added to the switching unit 46 to provide different electrical resistances to different circuit pathways in examples where the pad contacts 52 and the spring contacts 54 are made of the same material. The pad contacts 60, the conductors 28a, 30a and the bridge 50 can be made of the second material having the lower electrical resistivity.

In an open-circuit state (see FIG. 8), the contact bridge 50 and its pad contacts 52 of the moveable contact unit 48 are separated from the fixed contacts 47 such that the fixed contacts 47 are not electrically connected to one another by the contact bridge 50.

In a semi-closed circuit state (see FIG. 9), the moveable contact unit 48 is moved to a position in which the pad contacts 52 contact the spring contacts 54 of the fixed contacts 47 and do not contact the pad contacts 60 of the fixed contacts 47. This causes an electrical connection to be made through a first circuit path 56 (see FIG. 9) of having a first electrical resistance. Since the circuit path includes the spring contacts 54 having the higher electrical resistivity, the electrical resistance is dependent upon the spring contacts 54 and their higher electrical resistivity. The first circuit path 56 includes the spring contacts 54 made of the first material. The first circuit path 56 is connected between the first and second electrical conductors 28a, 30a via the bridge 50, the pad contacts 52 and the spring contacts 54 when there is initial contact between the pad contacts 52 of the contact bridge 50 and spring contacts 54.

In a closed-circuit state (see FIG. 10), an electrical connection can be made through a second circuit path 58 of lower electrical resistance than the first circuit path 56. The second circuit path 58 includes the pad contact 52 made of the second material. The second circuit path 58 is connected between the first and second electrical conductors 28a, 30a via the pad contacts 52 of the contact bridge 50 when the spring contacts 54 are compressed such that the pad contacts 52 of the contact bridge 50 are actuated to contact the fixed pad contacts 60 which may also be lower electrical resistance current carrying rivets. The rivets may define pockets such that the spring contacts 54 can be compressed down into the pocket and the pad contacts 52 contact the fixed pad contacts 60 and there is a metal to metal low electrical resistance connection. When in the closed-circuit state, the spring contacts 54 remain electrically connected to the pad contacts 52, 60. Thus, both circuit paths 56, 58 provide electrical connections between the electrical conductors 28a, 30a. But, due to the lower electrical resistance of the second circuit path 58, primary current flow occurs through the second circuit path 58.

1. An electrical connection arrangement for electrically connecting a first electrical conductor to a second electrical conductor, the electrical connection arrangement comprising:
a first circuit path having a first electrical resistance;
a second circuit path having a second electrical resistance that is lower than the first electrical resistance; and
the electrical connection arrangement being configured to provide a connection sequence for electrically connecting the first and second electrical conductors, the connection sequence including: a) a first electrical connection state in which the first and second electrical conductors are not electrically connected; b) a second electrical connection state in which the first and second electrical conductors are electrically connected by the first circuit path and are not electrically connected by the second circuit path; and c) a third electrical connection state in which the first and second electrical conductors are electrically connected by the first circuit path and by the second circuit path, wherein during the connection sequence, the second electrical connection state occurs sequentially after the first electrical connection state and the third electrical connection state occurs sequentially after the second electrical connection state.

2. An electrical connection arrangement for electrically connecting a first electrical conductor to a second electrical conductor, the electrical connection arrangement comprising:
a first circuit path having a first electrical impedance;
a second circuit path having a second electrical impedance that is lower than the first electrical impedance; and
the electrical connection arrangement being configured to provide a connection sequence for electrically connecting the first and second electrical conductors, the connection sequence including: a) a first electrical connection state in which the first and second electrical conductors are not electrically connected; b) a second electrical connection state in which the first and second electrical conductors are electrically connected by the first circuit path and are not electrically connected by the second circuit path; and c) a third electrical connection state in which the first and second electrical conductors are electrically connected by the first circuit path and by the second circuit path, wherein during the connection sequence, the second electrical connection state occurs sequentially after the first electrical connection state and the third electrical connection

3. The electrical connection of claim 1, wherein the first electrical conductor is a pin contact of a plug and the second electrical conductor is at least one pin receiving contact of a plug receptacle.

4. The electrical connection of claim 3, wherein the second electrical conductor includes a first pin receiving contact and a second pin receiving contact respectively made of first and second different materials, and wherein the first material has a higher electrical resistivity and is more erosion resistant than the second material.

5. The electrical connection arrangement of claim 4, wherein the first material includes stainless steel, and the second material includes copper, silver, or nickel, or combinations thereof.

6. The electrical connection arrangement of claim 1, wherein the connection sequence includes a fourth electrical connection state in which the first and second electrical conductors are electrically connected by the second circuit path and not by the first circuit path, wherein the fourth electrical connection state occurs sequentially after the third electrical connection state.

7. The electrical connection arrangement of claim 1, wherein the electrical connection arrangement is configured to provide a disconnection sequence for electrically disconnecting the first and second electrical conductors, wherein during the disconnection sequence, the electrical connection arrangement sequentially moves from the third electrical connection state to the second electrical connection state, and then from the second electrical connection state to the first electrical connection state.

8. The electrical connection arrangement of claim 7, wherein the electrical connection arrangement is configured to provide a disconnection sequence for electrically disconnecting the first and second electrical conductors, wherein during the disconnection sequence, the electrical connection arrangement sequentially moves from the fourth electrical connection state through the third and second electrical connection states to the first electrical connection state.

9. The electrical connection arrangement of claim 1, wherein the first and second circuit paths are arranged in parallel with respect to one another when the electrical connection arrangement is in the third electrical connection state.

10. The electrical connection arrangement of claim 3, wherein the pin contact of the plug is inserted inwardly into the at least one pin receiving contact of a plug receptacle along an insertion axis to provide the electrical connection between the first and second electrical conductors, wherein the pin contact is electrically connected to the first electrical conductor, wherein the first circuit path includes the pin contact of the first electrical conductor electrically connected to the first pin receiving contact of the second electrical conductor and the second circuit path includes the pin contact of the first electrical conductor electrically connected to the second pin receiving contact of the second electrical conductor, wherein the first and second pin receiving contacts are located within the plug receptacle, wherein the pin contact includes an electrically conductive portion and a dielectric portion, wherein the electrically conductive portion contacts the first pin receiving contact and not the second pin receiving contact when the electrical connection arrangement is in the second electrical connection state, wherein the electrically conductive portion contacts both the first and second pin receiving contacts when the electrical connection arrangement is in the third electrical connection state, and wherein the electrically conductive portion contacts the second pin receiving contact and the dielectric portion contacts the first pin receiving contact when in electrical connection arrangement is the fourth electrical connection state.

11. The electrical connection arrangement of claim 10, wherein the pin contact is at a first axial position within the plug receptacle when the electrical connection arrangement is in the second electrical connection state, wherein the pin contact is at a second axial position within the plug receptacle when the electrical connection arrangement is in the third electrical connection state, wherein the pin contact is at a third axial position within the plug receptacle when the electrical connection arrangement is in the fourth electrical connection state, and wherein the pin contact is inserted progressively further into the plug receptacle as the plug is moved from the first axial position through the second axial position to the third axial position.

12. The electrical connection arrangement of claim 3, wherein the first and second circuit paths respectively include first and second louvered electrical contacts within the plug receptacle for contacting the pin contact of the plug, the first and second louvered electrical contacts each including a plurality of slats for providing a plurality of contact locations circumferentially about the pin contact, the first and second electrical louvered electrical contacts being axially spaced apart from one another along a pin insertion axis of the plug receptacle, the first and second louvered electrical contacts being respectively being made of first and second different materials, wherein the first material has a higher electrical resistivity and is more erosion resistant than the second material.

13. The electrical connection of claim 1, wherein the first and second circuit paths are incorporated as part of a linear switch.

14. The electrical connection arrangement of claim 13, wherein the first circuit path includes a spring contact made of a first material, wherein the second circuit path includes a pad contact made of a second material, wherein the first material has a higher electrical resistivity and is more erosion resistant than the second material, wherein the first circuit path is connected between the first and second electrical conductors via the spring contact when the spring contact is engages the pad contact, and wherein the second circuit path is connected between the first and second electrical conductors via the pad contact when the spring is compressed such that the pad contact engages another pad contact.

15. The electrical connection arrangement of claim 14, wherein the contact spring and the pad contact are co-axially arranged with respect to each other.

16. The electrical connection arrangement of claim 1, wherein the first circuit path includes a first electrical contact having a first material composition with a first electrical resistivity, wherein the second circuit path includes a second electrical contact having a second material composition that is less erosion resistant than the first material composition and has a second electrical resistivity that is lower than the first electrical resistivity.
